(19) United States
(12) Patent Application Publication
(10) Pub. No.: US 2008/0049932 A1
(43) Pub. Date: Feb. 28, 2008

(54) KEY INFORMATION UPDATE RECORDING METHOD AND KEY INFORMATION UPDATE RECORDING APPARATUS

(76) Inventors: Tatsuya Ono, Fuchu-shi (JP); Yutaka Kawada, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/777,202

(22) Filed: Jul. 12, 2007

(30) Foreign Application Priority Data
Jul. 13, 2006 (JP) 2006-193156

(51) Int. Cl. H04L 9/00; H04L 9/30

(52) U.S. Cl. 380/44; 380/277

(57) ABSTRACT

According to one embodiment, a limited-access object is encrypted using key information, such as Title Key File, to be updated. The encrypted object data is recorded onto a medium such as an optical disc or HDD. The key information update process, including the resetting and re-encryption of key information, and the process of writing the update information obtained as a result of the update process onto the medium are carried out in a batch with or at specific timing.

### CROSS-REFERENCE TO RELATED APPLICATIONS

This application is based upon and claims the benefit of priority from Japanese Patent Application No. 2006-193156, filed Jul. 13, 2006, the entire contents of which are incorporated herein by reference.

### BACKGROUND

1. Field

One embodiment of the present invention relates to information access management using an encryption key or the like, and more particularly to a method of updating a key used to protect highly confidential data.

2. Description of the Related Art

In recent years, various digital devices for accessing contents recorded on disc media or the like have been developed. The data recorded on a disc accessed by such a device has been encrypted to prevent unauthorized access or illegal copy. In the case of the encrypted data, an encryption scheme mainly complying with the CSS (Content Scramble System) scheme has been employed in the DVD (Digital Versatile Disc).

As a more advanced encryption scheme, an AACS (Advanced Access Content System) has been proposed (Jpn. Pat. Appln. KOKAI Publication No. 2005-39480). To employ the AACS scheme, for example, a set maker gets a specific key set from a key matrix a licensee has, encrypts a key with a different combination, and set the encrypted key in each device. Moreover, a method of updating an encryption key cumulatively has been proposed (Jpn. Pat. Appln. KOKAI Publication No. 2002-300151).

In the AACS, each of a plurality of keys is encrypted using not only a device key given to each device which records and reproduces contents duly but also a random number randomly generated, and the encrypted key, together with the random number, is registered in a key file and then recorded onto a medium. When content is reproduced, the encrypted key registered in the key file is decrypted using the random number and the device key of the device to be reproduced. Then, the content is decrypted using the decrypted key, thereby reproducing the content.

Information on the encrypted key and decrypted key is updated many times in the middle of recording on the medium repeatedly. It takes time to update the keys. For this reason, when an update process has interrupted during use, the user might run into unpleasant experiences, while waiting for the process to end.

### BRIEF DESCRIPTION OF THE SEVERAL VIEWS OF THE DRAWINGS

FIG. 1 is an exemplary diagram to help explain the configuration of data (a title key file) in a medium (information recording medium) according to an embodiment of the invention;

FIG. 2 is an exemplary diagram to help explain an example of the process of decrypting encrypted contents recorded on a medium;

FIG. 3 is an exemplary diagram to help explain an example of the process of encrypting contents and recording the encrypted ones onto a DVD;

FIG. 4 is an exemplary diagram showing the structure of a title key file and a title key file as its backup file;

FIG. 5 shows exemplary data on a medium needed in a recording and reproducing process using an encryption scheme (AACS scheme) employed in the embodiment;

FIG. 6 shows exemplary data on a medium needed in a recording and reproducing process in the AACS scheme;

FIG. 7 shows exemplary data on a medium needed in a recording and reproducing process in the AACS scheme;

FIG. 8 shows an exemplary structure of an encrypted title key file (E-TKF);

FIG. 9 is an exemplary block diagram to help explain an example of the configuration of a recording and reproducing apparatus (HD_DVD recorder) according to the embodiment;

FIG. 10 is an exemplary flowchart to help explain a recording method according to the embodiment;

FIG. 11 is an exemplary flowchart to help explain a reproducing method according to the embodiment;

FIG. 12 is an exemplary flowchart to help explain a key information update recording method according to the embodiment;

FIG. 13 is an exemplary flowchart to help explain a key information update recording method according to another embodiment of the invention;

FIG. 14 is an exemplary flowchart to help explain a key information update recording method according to still another embodiment of the invention;

FIG. 15 is an exemplary flowchart to help explain a key information update recording method according to still another embodiment of the invention; and

FIG. 16 is an exemplary flowchart to help explain a key information update recording method according to still another embodiment of the invention.

### DETAILED DESCRIPTION

One task according to an embodiment of the invention is to provide a method of letting the user not wait for the end of the key information update process as much as possible.

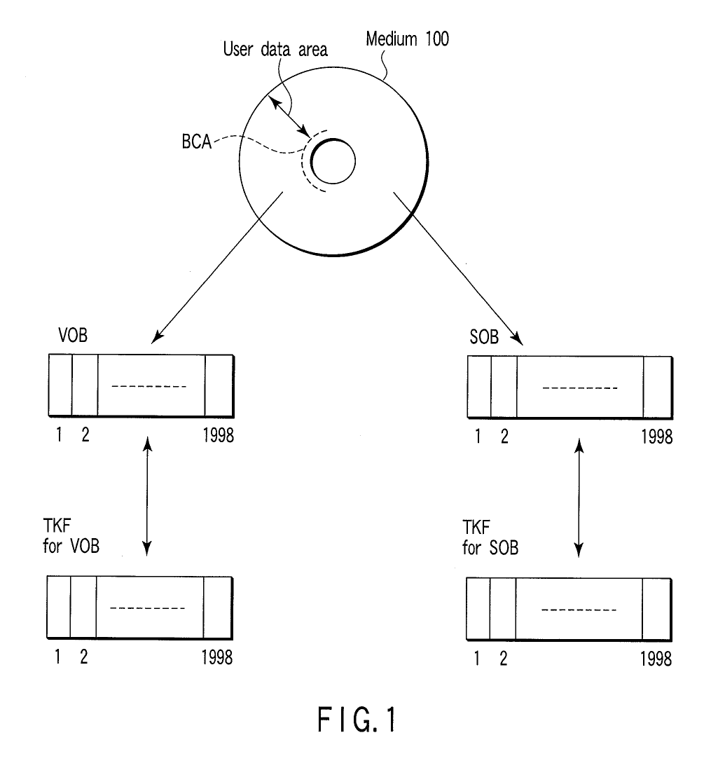

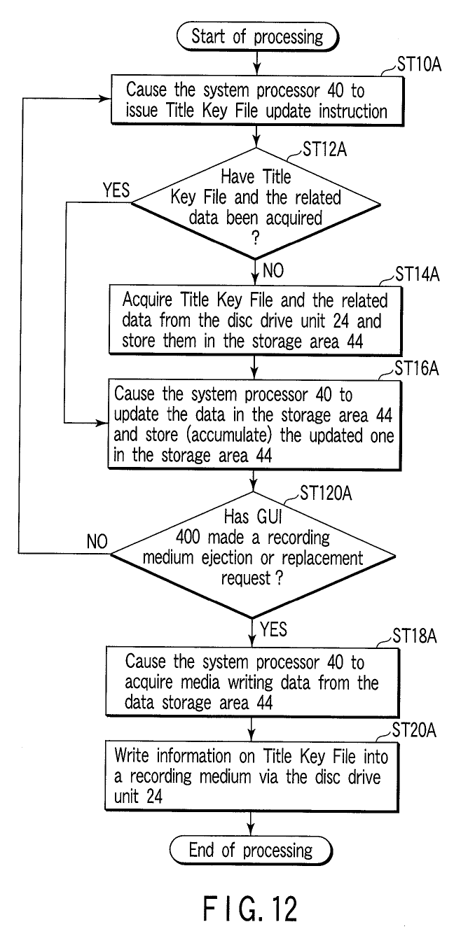

A method according to an embodiment of the invention is used in encrypting an (limited-access) object (VOB/SOB) using key information to be updated (such as Title Key File) and recording the encrypted object data onto a medium (an optical disc/HDD). In the method, the key information update process (the resetting and re-encryption of key information) and/or the process of writing update information obtained as a result of the update process onto the medium are carried out in a batch (ST20A to ST20E in FIGS. 12 to 16) at specific timing (Yes at ST120 in FIG. 1 or Yes at ST120A to ST120E in FIGS. 12 to 16).

It is possible to let the user not wait for the end of the key information update process as much as possible.

Hereinafter, referring to the accompanying drawings, embodiments of the invention will be explained. When information is recorded onto an information recording medium, such as an optical disc, it is sometimes needed to encrypt information and record the encrypted one. In that case, for example, copyright-protected contents are encrypted using an encryption key, thereby obtaining the encrypted contents. To make a secret of the encryption key used in encryption, the encryption key is encrypted using another encryption key, thereby producing an encryption key. Then, the encrypted contents, together with the encryption key, are recorded onto a recording medium, thereby preventing illegal copy.

In the field of DVDs (Digital Versatile Discs) whose market is now expanding rapidly, the following measures have been taken for copyright protection: DVD video uses the CSS (Content Scramble System) method licensed by the DVD CCA (DVD Copy Control Association) and DVD audio uses the CPPM (Content Protection for Prerecorded Media) method. In the copyright protection method for contents recorded in recording media, the CPRM (Content Protection for Recordable Media) method has been used. The CPPM method and CPRM method have been licensed by specific associations (e.g., an association known as 4C Entity, LLC).

On the other hand, a high-capacity next-generation DVD or the like capable of recording and reproducing higher-resolution images and higher-quality multichannel audio signals has been under development. In a copyright protection method in recording high-quality work into such a next-generation recording medium, the introduction of a method whose security capability is made higher than before is needed. One concrete example of the method is the AACS (Advanced Access Content System) method. Hereinafter, a method of managing content keys in the AACS will be explained which is the content protection technique used in the HD_DVD-VR (High Density Digital Versatile Disc Video Recording) format.

In the conventional CPRM method, an encryption key is generated using a media key block (MKB) and a media ID which exist on the disc and contents are encrypted. In the AACS method, contents on the disc are encrypted using an encryption key for each of the contents, not using a common single encryption key.

FIG. 1 shows an example of the configuration of data on a medium 100. In the example, the medium is capable of storing a maximum of 1998 video objects (VOB), such as contents in the MPEG2-PS format, and a maximum of 1998 stream objects (SOB), such as the MPEG2-TS format according to the standard. In the conventional method, one encryption key is used for all of the objects, whereas the objects are encrypted using an encryption key differing from content to content in the AACS method. The encryption key for each of the contents is stored in a title key file (TKF). Specifically, there are provided a video object title key file and a stream object title key file. In each title key file, a maximum of 1998 encrypted title keys (abbreviated as E-TK) can be stored.

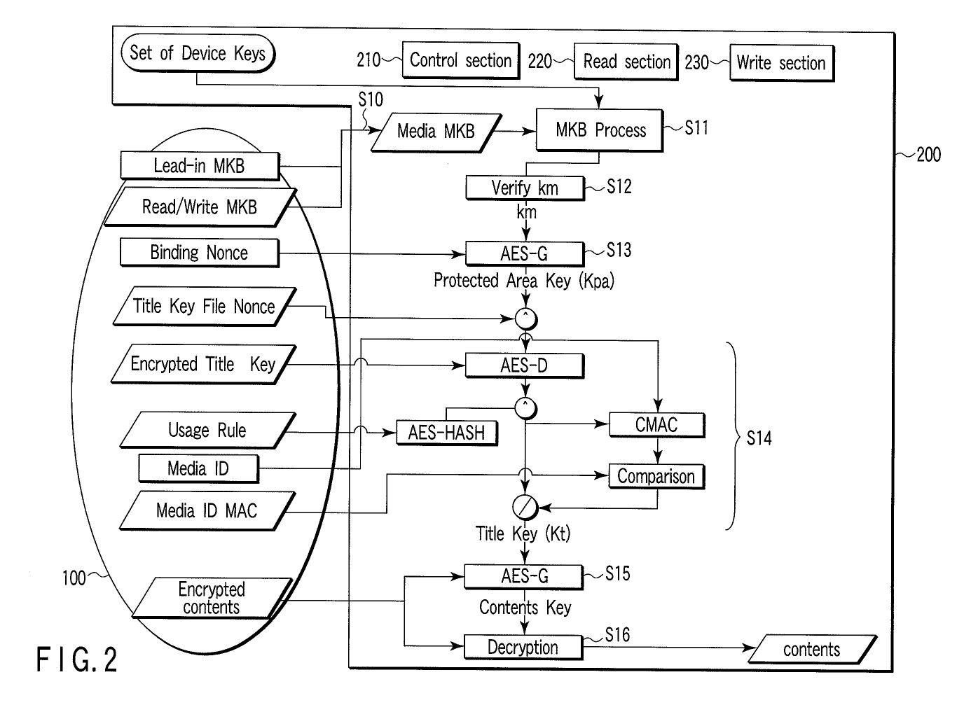

FIG. 2 is a diagram to help explain the process of decrypting encrypted contents recorded on the medium 100. FIG. 2 shows information stored on the medium 100 on which contents and others have been recorded, the processing functions provided in an information recording and reproducing apparatus 200, and the flow of data between the functions.

The content protection technique used in the HD_DVD video recording format is the AACS. A method of managing content keys in the AACS will be explained using FIG. 2. Data recorded in an unrewritable area on the disc used in an AACS process includes:

Media ID

Lead-in MKB

Data which is used in an AACS process and exists as a file on the disc 100 includes:

Read Write MKB

Title Key File

Title Usage File

In a protect area at the begin address in the Title Key File, data based on a random number called Binding Nonce has been recorded.

In the AACS, the process of generating a “title key (Kt)” for encrypting contents is roughly carried out in the following sequence. First, using the one with a newer version of Lead-in MKB and Read Write MKB, an MKB process is carried out. The key generated in the process is called “media key (Km).” Using the media key Km and Binding Nonce as inputs, a protected area key process (Kpa process) is carried out, thereby generating a “protected area key (KPa).” Using the Kpa, the data in the Title Usage File, and the data in the Title Key File, a Title Key process (TK process) is carried out, which enables the encrypted title key recorded in the Title Key File to be converted into the original title key Kt.

The MKB is data called a Media Key Block and is such that the media key Km is encrypted and recorded. Also in the MKB, information on unauthorized devices has been recorded. Unauthorized devices are prevented from taking out Km. Since information on unauthorized devices is updated, the latest version of the MKB has to be used. For this reason, in the HD_DVD AACS, there are three types of MKB: Lean-in MKB embedded in the Lead-in Area of the medium, Read Write MKB held as a file on the disc, and MKB (hereinafter, referred to as Device MKB) stored in an internal nonvolatile memory by the device itself. Of them, the latest MKB is supposed to be written over the Read Write MKB. Since updating the MKB to the new one involves the change of the value of Km, all of the key information including Km and subsequent ones (including Kpa and Kt) has to be created again.

In the information recording and reproducing apparatus 200, there are provided a control section 210, a read section 220, and a write section 230. The control section 210 controls each function and each processing operation in the information recording and reproducing apparatus 200. The read section 220 reads data from the medium 100 into the information recording and reproducing apparatus 200. The write section 230 writes the data in the information recording and reproducing apparatus 200 onto the medium 100.

In a read-only lead-in area of the medium 100, a Lean-in MKB (Media Key Block) is stored. In a User Data area, a rewritable area, a Read Write MKB is stored. The MKB is a media key block obtained by encrypting a media key (Km), a base key for content encryption, on the basis of a set of device keys (Kd) provided as private keys in the information recording and reproducing apparatus 200 and organizing a mathematical system.

In S10 of FIG. 2, the version of Lead-in MKB recorded on the medium 100 is compared with the version of Read Write MKB. After it is determined that the version of Read Write MKB is equal to or higher than the version of Lead-in MKB, Read Write MKB is read as Media MKB. If only Lead-in MKB exists on the medium 100, Lead-in MKB is read as Media MKB. Then, in S11, an MKB process is carried out using a device key set (or a set of device keys) stored in the information recording and reproducing apparatus 200 and Media MKB. The device key set is composed of a plurality of device keys Kd.

The MKB includes not only encrypted information for generating a protected area key (Kpa) but also revoke information. Specifically, when a certain device key set has a security hole in it and the licenser bans the use of the relevant device key Kd, revoke information on the relevant device key Kd is written. The revoke information prevents a device with the relevant device key Kd from decrypting the secret code (that is, the revoked information cannot be reproduced). Since information on unauthorized devices is updated progressively as time passes, a new MKB (the latest updated MKB) has to be used. For this reason, the latest version of the MKB is used as Media MKB.

By the MKB process, a media key (Km) is generated. In S12 of FIG. 2, the generated media key is verified. If the result of the verification has shown that the generated media key is unauthorized, the device key set is considered to be unauthorized and the process in the AACS is terminated.

In a protect area of the begin address of the title key file (TKF), “random-number-based data” coupled with a file called Binding Nonce has been recorded. The Binding Nonce cannot be copied using, for example, a Write instruction on the PC (personal computer). It can be copied using only an instruction defined in the AACS. Enabling a copy to be made only by the hardware given license for the AACS prevents information from leaking via the PC.

Next, in S13 of FIG. 2, using Km and Binding Nonce, a Kpa process, an encryption process, is carried out. In the Kpa process, an AES (Advanced Encrypted Standard)-G, an encryption algorithm, is used. As a result of the Kpa process, a protected area key (Kpa) is generated.

Next, a title key process for generating a title key (TK) from Kpa will be explained. The process is shown in S14 of FIG. 2. In the title key file (TKF), random number data called TKFN (Title Key File Nonce) is stored. The TKFN is random number data used to encrypt a title key in an encrypting process (described later). Moreover, the disc 100 is further provided with a Title Usage File in which rules on use of contents have been written. In the Title Usage File, information (Usage Rule) on whether or not each of the rules on use is applied is written in the form of Bit information 0 or 1.

Furthermore, in a read-only burst cutting area (BCA) provided medial to the lead-in area of the disc, Media ID has been recorded. Media ID is a unique ID assigned to each medium. In a user data area, a rewritable area, Media ID MAC, tamper-proof code MAC (Message Authentication Code) using Media ID, has been stored.

In a title key process shown in S14 of FIG. 2, on the basis of the result of processing the above Usage Rule and Kpa and TKFN, a process using an AES-D algorithm is carried out and the encrypted title key (E-TK) is decrypted, thereby generating a title key (TK). At this time, the MAC generated using Media ID stored in the BCA is compared with the Media ID MAC stored on the disc, thereby verifying that the data has not been tampered with. In S15 of FIG. 2, the TK generated this way and the encrypted contents are processed by an AES-G algorithm, generating a content key. In S16, using the content key, the encrypted contents are decrypted, generating contents.

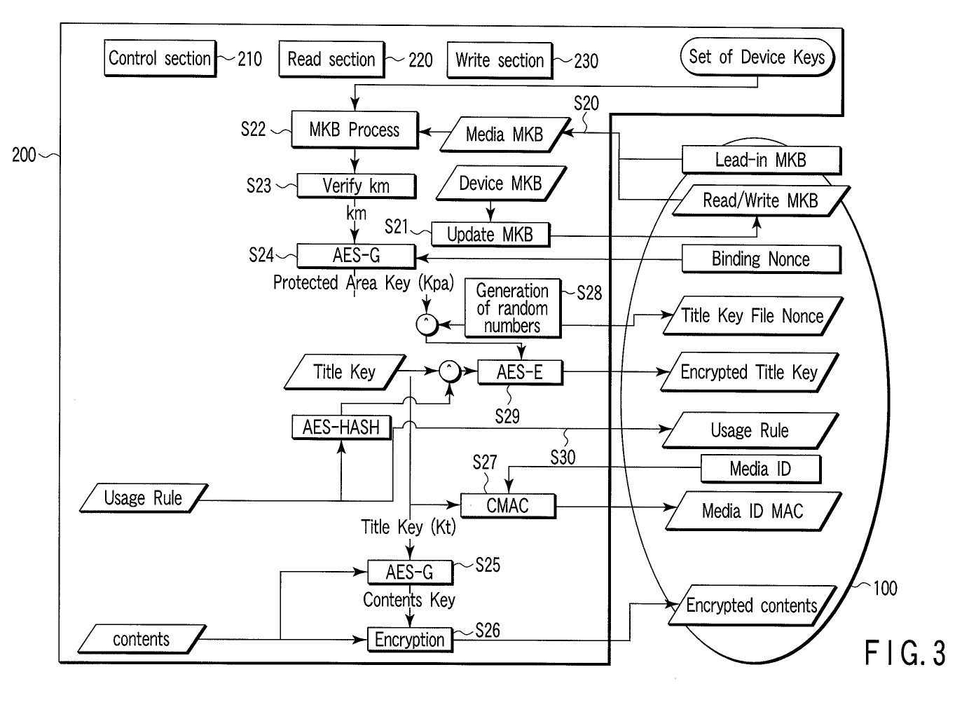

FIG. 3 is a diagram to help explain the process of encrypting contents and recording the encrypted ones onto the optical disc 100, such as HD_DVD-R/RW/RAM. Since the terms used are the same as those in FIG. 2, an overlapping explanation will be omitted. In S20 of FIG. 3, the version of Lead-in MKB and Read Write MKB recorded on the medium 100 are compared with each other and the MKB of the latest version is read as Media MKB. Next, the version of Media MKB is compared with the version of Device MKB held by the information recording and reproducing apparatus 200. The version of Device MKB is newer, an MKB update process is started in S21 and the value of Device MKB is updated to Read Write MKB. However, if the version of Media MKB is newer, whether to update the value of Device MKB depends on the specification of the set. Then, in S22 of FIG. 3, using the device key set and Media MKB held in the information recording and reproducing apparatus 200, the MKB process is carried out. By the MKB process, a media key (Km) is generated.

In S23 of FIG. 3, the generated media key is verified. If the result of the verification has shown that the generated media key is unauthorized, the device key set is regarded as unauthorized and the process related to the AACS is terminated. In S24 of FIG. 3, using Km and Binding Nonce, a Kpa process, an encryption process, is carried out. As a result of the Kpa process using AES-G, a protected area key (Kpa) is generated.

In S25 of FIG. 3, the title key (TK) and contents are processed by an AES-G algorithm, thereby generating a content key. Then, in S26, using the content key, contents are encrypted, generating encrypted contents, which are recorded onto the medium 100. In S27, using Media ID and TK, MAC is generated and stored as Media ID MAC. In S28, random number data used to encrypt the title key is created and stored as Title Key File Nonce onto the medium 100. Then, in S29, on the basis of the result of subjecting the Usage Rule to a hash process (known technique), a process using an AES-E algorithm is carried out, thereby generating an encrypted title key (E-TK) and storing the resulting key onto the medium 100. The Usage Rule is recorded onto the medium 100 in S30.

As described above, the title key and the like play a significant role in encrypting and decrypting contents. However, since the title keys and the like have been recorded as a readable/writable file on the medium 100, if the surface of the medium is smeared with, for example, a fingerprint, the medium might easily go into a state where contents cannot be read. Thus, in the AACS, the title key file (TKF) which stores information on those title keys is backed up.

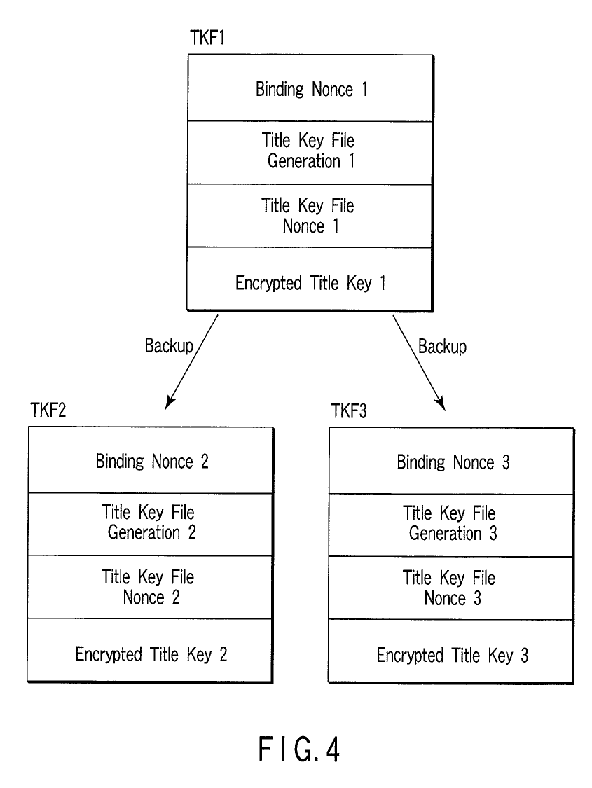

FIG. 4 is an explanatory diagram showing an example of the structure of the title key file and a title key file serving as its backup file. In the explanation of the backup method, the title key file is represented as TKF1 and the title key files serving as backup files are represented as TKF2 and TKF3. TKF1 to TKF3 have been stored on the medium 100.

In the title key files (TKF1 to TKF3), Binding Nonce 1 to Binding Nonce 3 (BN1 to BN3), Title Key File Generation 1 to Title Key File Generation 3 (TKFG1 to TKFG3), Title Key File Nonce 1 to Title Key File Nonce 3 (TKFN1 to TKFN3), and Encrypted Title Key 1 to Encrypted Title Key 3 (ETK1 to ETK3) have been registered, respectively. Here, Binding Nonce 1 to Binding Nonce 3 (BN1 to BN3) are random number data used in encrypting its own title key file as described above. Title Key File Generation 1 to Title Key File generation 3 (TKFG1 to TKFG3) represent the number of times each of the Title Key Files (TKF1 to TKF3) is updated. Title Key File Nonce 1 to Title Key File Nonce 3 (TKFN1 to TKFN3) are random numbers for generating Encrypted Title Keys (ETK1 to ETK3) excluding its own title key file or backup file.

Encrypted Title Key 1 to Encrypted Title Key 3 (ETK1, ETK2, ETK3) are expressed by the following equations (eq. 1) to (eq. 3):
ETK1=f(TK, BN1, TKFN3) (eq. 1)
ETK2=f(TK, BN2, TKFN1) (eq. 2)
ETK3=f(TK, BN3, TKFN2) (eq. 3)

where TK is an unencrypted plain text title key and the encrypting function f means encrypting a first parameter (TK) using second parameters (BN1 to BN3) and third parameters (TKFN1 to TKFN3) as encryption keys. A known encryption algorithm, such as the AES (Advanced Encryption Standard), is used as the encrypting process f.

Specifically, TKF1 is related to TKF3. TKF1 is obtained by encrypting the title key (TK) using (BN1) and (TKFN3) of the related TKF3. TKF2 is related to TKF1. TKF2 is obtained by encrypting the title key (TK) using (BN2) and (TKFN1) of the related TKF1. TKF3 is related to TKF2. TKF3 is obtained by encrypting the title key (TK) using (BN3) and (TKFN2) of the related TKF2.

As described above, the title key file TKF1 and the backup files TKF2, TKF3 are related to one another. The encrypted title keys (E-TK1, E-TK2, E-TK3) are obtained by encrypting the title key (TK) using (BN1, BN2, BN2) registered in its own file and (TKFN1, TKFN2, TKFN3) registered in the related other file.

By storing three TKFs and storing TKFN in another file as described above, the damaged data can be restored to its original form from the data in the remaining two TKFs even if one TKF has been damaged because of data corruption.

Setting the aforementioned Binding Nonce as data that can be read and written only by a special drive command makes it possible to prevent an unauthorized copy. That is, even if the TKF has been copied, its accompanying Binding Nonce is not copied, which prevents a malicious third party from performing unauthorized encryption/decryption.

Relating the title key file to TKFN in another file of each backup file is not limited to the equations (eq. 1) to (eq. 3). Patters other than the equations (eq. 1) to (eq. 3) may be used to relate the title key file to TKFN in the backup files.

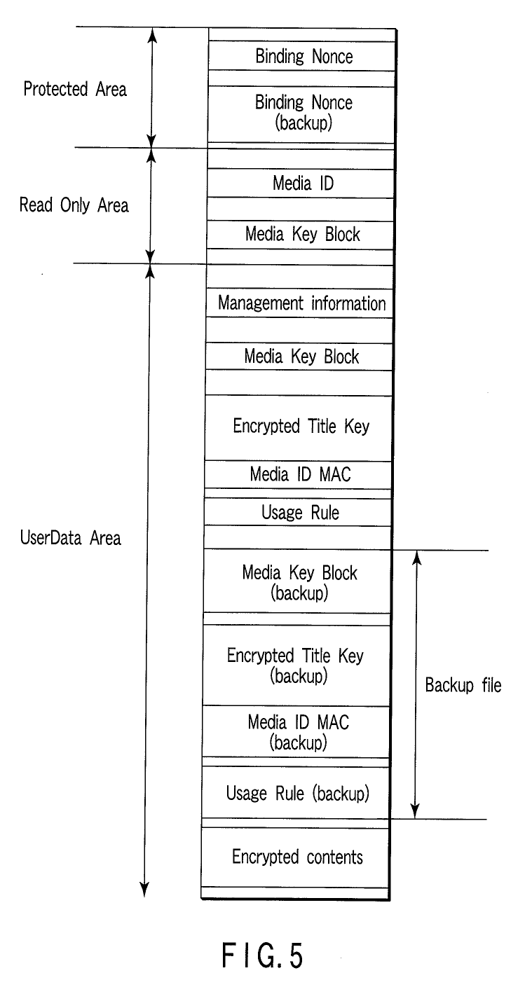

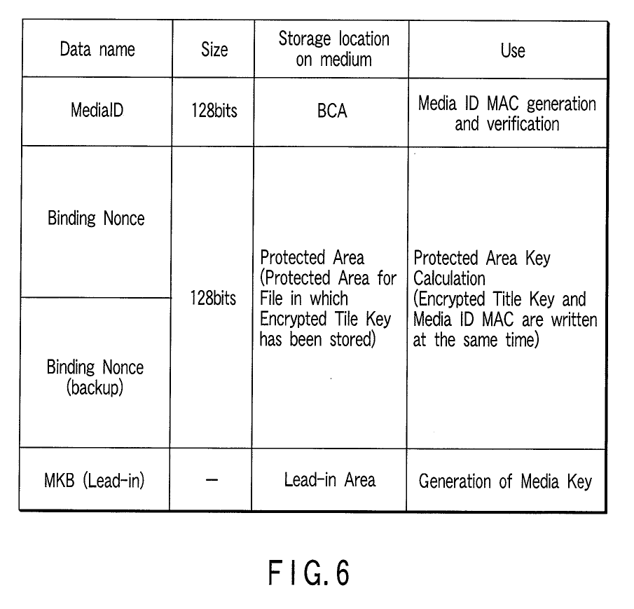

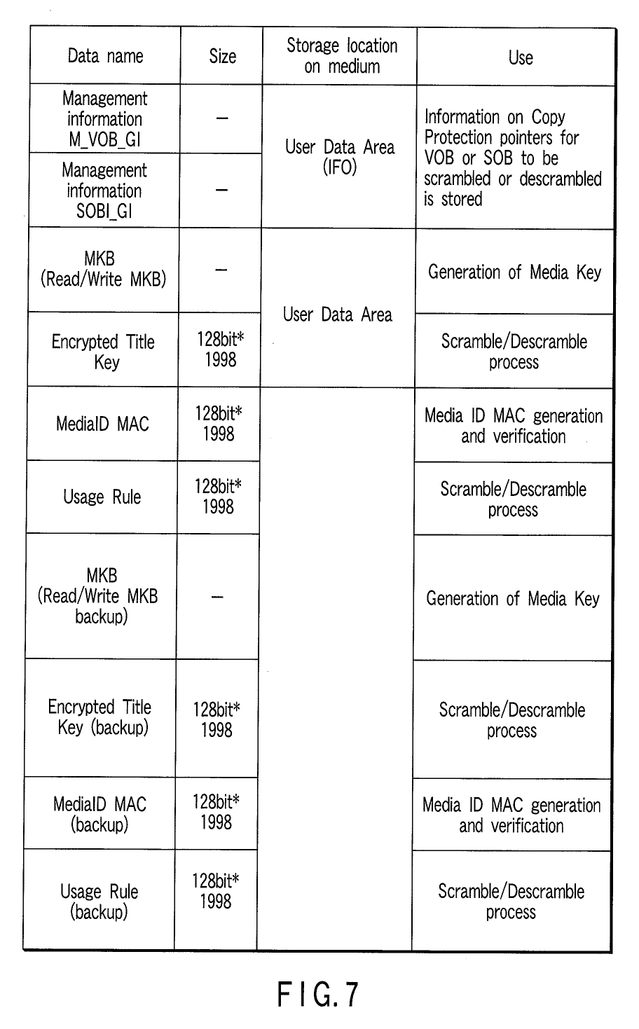

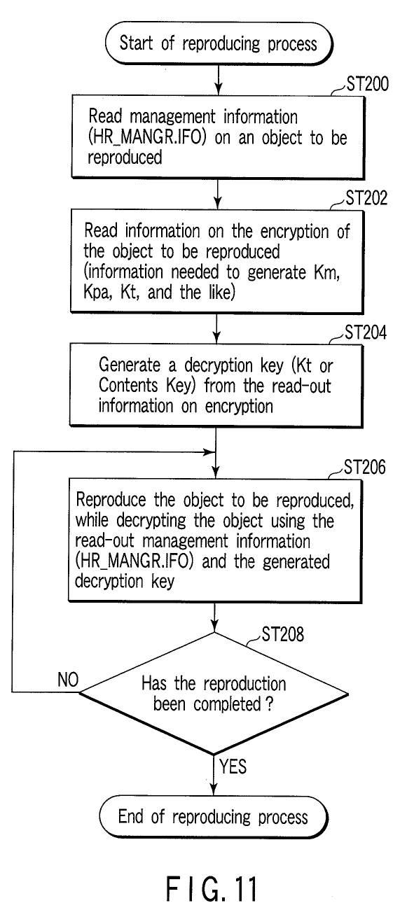

Data on the medium needed in an AACS recording and reproducing process will be explained in detail with reference to FIGS. 5, 6, and 7. In a Protected Area on the medium 100, that is, in a Protected Area of a file in which E-TK has been stored, Binding Nonce and its backup data have been stored. Moreover, in a BCA (Burst Cutting Area) in a read-only area of the medium 100, Media ID has been recorded. In a lead-in area (110 in FIG. 11 described later), Lead-in MKB has been recorded.

In a user data area on the medium 100, management information, information on a Copy Protection Pointer for a video object (VOB) and/or a stream object (SOB), has been stored. In a user data area, Read Write MKB, encrypted title key (E-TK), Media ID MAC, Usage Rule, and their backup files have been stored. Moreover, the user data area is configured to be capable of storing a maximum of 1998 encrypted contents.

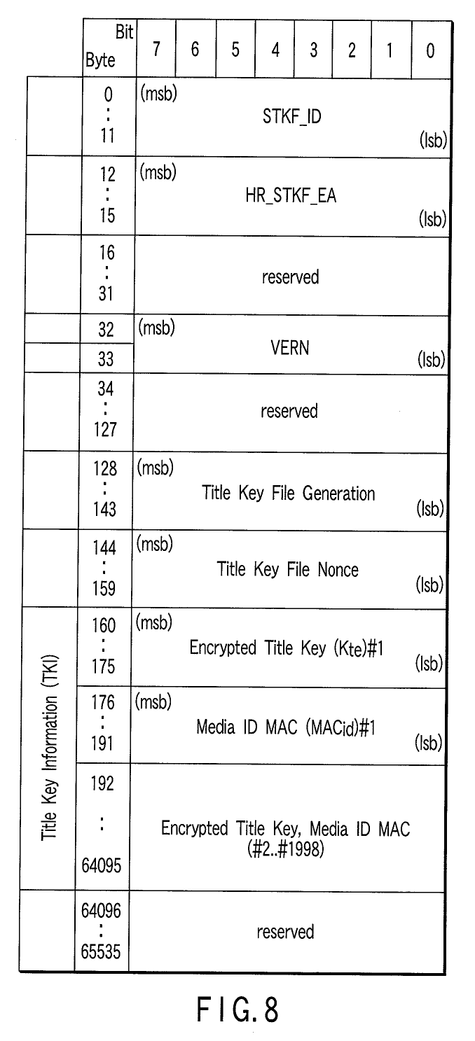

FIG. 8 shows the structure of an encrypted title key file (E-TKF). FIG. 8 shows an E-TKF structure of a stream object (SOB). A video object (VOB) has the same structure. In the byte locations ranging from byte 0 to byte 15, fixed information (STKF_ID, HR_STKF_EA) for identifying a title key file is written. In byte 32 and byte 33, the version number of the AACS is written. In the range from 128 byte to 143 byte, Title Key File Generation is stored. In the range from byte 144 to byte 159, Title key File Nonce is stored. In the range from byte 160 to byte 64095, 1998 pairs of encrypted title key (E-TK) and Media ID MAC are written as Title Key Information (KTI).

Each of the contents has been encrypted using one of the 1998 title keys. Encrypted Title Keys need not be recorded for all of the 1998 contents. In an unused content, a value obtained by encrypting the value 0 by a TK process is written. In the Title Key File Generation, the value incremented each time the file is updated is written. As described above, the title key file includes a total of three files as backups. If all of the values of the Title Key File Generation of the three files do not coincide with one another, this means that a failure has occurred in the middle of writing a file.

Next, a method of updating the title key file will be explained. The media to which the AACS has been applied include rewritable media and write-once media. In the rewritable media, for example, since a new title key is added each time a new content is additionally recorded, all the title keys in the title key file have to be encrypted again using a new Kpa. That is, the update of the title key file is needed.

In the protect area of the title key file, a value based on Binding Nonce, a random number, has been written. The Binding Nonce is used to prevent unauthorized decryption. Therefore, the Binding nonce is also updated each time the title key file is updated.

In the write-once media, each time the title key file is updated, the title key file is written in a new address. For this reason, the address in which the Binding Nonce is written also differs each time. However, in the AACS, Binding Nonce has to be written over in the same place. Thus, in the write-once media, the title key file has to be prevented from being updated. Accordingly, the rewritable media differs from the write-once media in the title key file update conditions.

In the Title Key File of FIG. 8, 1998 encrypted title keys have been recorded. Contents are encrypted using one of the 1998 keys. Encrypted Title Keys need not be recorded for all of the 1998 contents. In an unused content, a value obtained by encrypting the value 0 by a TK process is written. In the Title Key File Generation, the value incremented each time the file is updated is written. The Title Key File is for storing title keys. If the Title Key File cannot be read because of a defect in the medium or the like, the content cannot be reproduced at all. For this reason, the Title Key File is written into three files as backups. If all of the values of the Title Key File Generation of the three files do not coincide with one another, this means that a failure has occurred in the middle of writing a file.

In a protect area at an address in which a Title Key File has been written on the medium 100, a value based on Binding Nonce, a random number, has been recorded. The protect area is an area where reading and writing can be done only by a special command dedicated to the AACS. Recording an element constituting Kpa makes it possible to prevent unauthorized decryption using a personal computer or the like.

The title key in the Title Key File is encrypted by combining the protected area key and Binding Nonce and carrying out the TK process. At this time, encryption is performed in such a manner that Binding Nonce in Title Key File#2 is used to encrypt Title Key File#1 and Binding Nonce in Title Key File#3 is used to encrypt Title Key File#2. By doing this, even if one of the three Title Key Files has been damaged, the damaged file can be restored to its original form by using the remaining two files. As described above, since Binding Nonce is used in encrypting title keys, it is updated each time the Title Key File is updated.

The Binding Nonce depends on an address in which a file is written. In the write-once media, such as HD_DVD-R, the Title Key File itself is stored in a new address each time, with the result that the Binding Nonce is also written in more than one place. However, since Binding Nonce is supposed to be written over in the same place in the AACS, the Title Key File is not updated in the write-once media.

In the Title Key File, 1998 encrypted title keys can be stored. The number coincides with the number of video objects (VOB) and stream objects (SOB). This is based on the assumption that the title key (Kt) is changed video object by video object. The reason is that, for example, when the contents are moved from the disc to another medium, a loophole that permits an unauthorized copy is left unless the title key in use has been eliminated. When the title key has been eliminated, the other objects with which the same title key is shared cannot be decrypted. Therefore, keys differing from one object to another have to be allocated as much as possible. For this reason, in the recording and reproducing apparatus, a new title key is generated each time a recording process is carried out. Using the title key, video objects and stream objects are encrypted.

Particularly when recording is done using stream objects (SOB), the stream objects have to be divided dynamically according to the contents of digital broadcasting to be recorded. Specifically, when the components of a stream object (SOB) have changed as the number of audio streams has changed at the boundary between programs, the SOB is divided automatically there. In this case, it is virtually impossible to change title keys there (an attempt to change title keys needs the time to generate a new key and therefore video recording at the beginning of the SOB lacks in starting the recording of the SOB after division). In such a case, encryption using the same title key is performed continuously.

If the disc belongs to the write-once media (or the medium which cannot be overwritten), the Title Key File cannot be updated. Thus, in the process of generating a key at the start of video recording, an already existing title key is used.

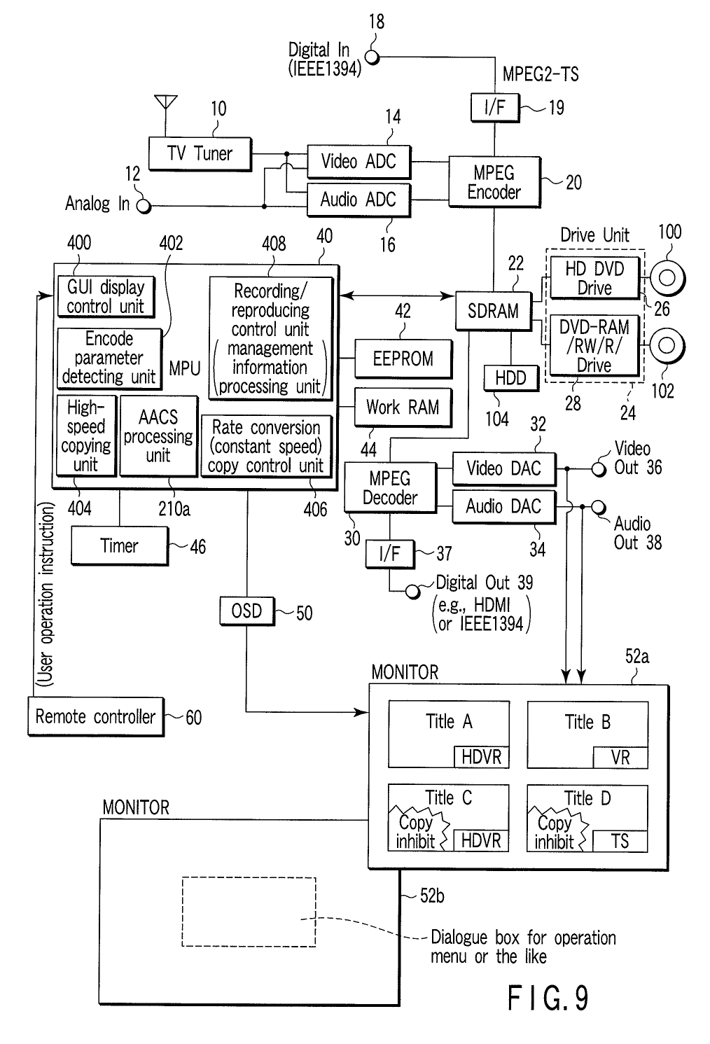

In a case where a rewritable medium (such as HD_DVD-RW/RAM or HDD) is used as the medium 100, the procedure for updating a title key file on a rewritable medium is, for example, as follows. Suppose a title key file has already been generated and written in the rewritable medium. The processing operation is realized by the control section 21 (or the firmware of the AACS processing section 210a of FIG. 9 described later) of the information recording and reproducing apparatus 200.

For example, when the user turns on the power supply of the information recording and reproducing apparatus 200 and inserts a rewritable medium, an MKB process and a TKF read process are executed in unison. In the MKB process, the signatures attached to Read Write MKB and Lead-in MKB are verified. If the result of the verification has authenticated the validity of them, the version of each MKB is acquired. The version of Read Write MKB has to be equal to or newer than the version of Lead-in MKB. If not, reproduction and recording are limited. In the TKF reading process, the title key file on the medium is developed on an SDRAM (such as 22 in FIG. 9 described later).

Then, according to the user's content recording operation, content editing operation, content deleting operation, media ejecting operation, or power OFF operation of the information recording and reproducing apparatus 200, it is determined whether or not the title key file is updated. Specifically, of the following three conditions, only when at least one of them is satisfied, the title key file is updated:

(1) When contents are recorded or deleted.

When contents are recorded or deleted, Encrypted Title Key in the title key file is newly added or deleted. Thus, the title key file is updated.

(2) When MKb is updated.

For example, when the version of Device MKB, MKB held in the information recording and reproducing apparatus 200, is newer than the version of Read Write MKB, the value of Device MKB is copied to Read Write MKB and the media key (Km) of Device MKB is updated. When Km is updated, Kpa is also updated. Therefore, the title key file is updated and the title key is encrypted again.

(3) When only one of the three Title Key File Generations is different.

As described above, this means that one of the three title key files has been damaged. For this reason, using the remaining two normal title key files, the damaged title key file is restored (updated) to its original form. That is, when at least one of the three conditions is fulfilled, the title key file is updated. None of the three conditions are fulfilled, the title key file is not updated and the process is terminated.

When a write-once medium (such as a single-sided single-layer HD_DVD-R or a single-sided double-layer HD_DVD-R:DL) is used, the procedure for writing a title key file in a write-once medium is as follows. The processing operation can be executed by the control section 210 (or the AACS processing section 210a of FIG. 9) of the information recording and reproducing apparatus 200.

For example, when the user turns on the power supply of the information recording and reproducing apparatus 200 and inserts a write-once medium, an MKB process and a TKF read process are executed in unison. In the MKB process, the signatures attached to Read Write MKB and Lead-in MKB are verified. If the result of the verification has authenticated the validity of them, the version of each MKB is acquired. The version of Read Write MKB has to be equal to or newer than the version of Lead-in MKB. If not, reproduction and recording are limited. In the TKF reading process, the title key file on the medium is developed on an SDRAM (such as 22 in FIG. 9).

Then, according to the user's content recording operation, content editing operation, content deleting operation, media ejecting operation, or power OFF operation of the information recording and reproducing apparatus 200, it is determined whether or not the title key file is written. Specifically, if the following two conditions are fulfilled, the title key file is written:

(1*) When contents are recorded.

(2*) When no title key file has been recorded on the disc.

Since Title Key File has to be written over in the same place in the AACS, only when condition (1*) and condition (2*) are satisfied at the same time, Title Key File is written in the write-once media. The reason for this will be described below.

If only condition (1*) is fulfilled, a write request is made each time contents are recorded. This becomes a problem in the case of write-once media incapable of writing over in the same place. If only condition (2*) is fulfilled, no valid content key has been generated in a state where no content has been recorded on the disc and therefore the Title Key File has only invalid Encrypted Title Keys, which is a problem. If both condition (1*) and condition (2*) have been satisfied, writing is done when recording has been done in a state where no Title Key File has been recorded on the disc. Accordingly, a Title Key File in which only one valid Encrypted Title Key has been generated is recorded.

If both of the two conditions are met, the title key file is written onto the disc. If none of the two conditions are met, the title key file is not written and the process is terminated.

With the embodiment, the condition for writing a title key file is set by media type. Only when the condition is satisfied, the title key file is written onto the disc. According to the condition, the Title Key File is not updated uselessly in the case of rewritable media, which enables the number of times Title Key File is written to be decreased. In the case of write-once media, the possibility of writing a problematic Title Key File can be eliminated.

A typical example of a recordable or rewritable information storage medium is a DVD disc (a single-recording-layer or multi-recording-layer EVD±R, DVD±RW, or DVD-RAM using red laser light with a wavelength of about 650 nm or violet-blue or blue laser light with a wavelength of 405 nm or less) 100. The disc 100 includes a volume/file structure information area in which a file system exists and a data area in which data files are actually recorded. The file system is composed of information indicating where which file has been recorded.

The data area includes an area in which a general computer records data and an area in which audio video data (AV data) is recorded. The AV data recording area is composed of an AV data management information area in which a video manager file (VMG or HDVR_MG) for managing AV data exists, a ROM_video object group recording area in which a file of object data complying with the DVD-Video (ROM Video) standard is recorded, a VR object group recording area in which a file (VRO file) of object data (ESOBS: Extended Video Object Set) complying with the video recording (VR) standard is recorded, and a recording area in which a stream object data (ESOBS: Extended Stream Object Set) file (SRO file) where objects compatible with digital broadcasting has been recorded is recorded. The recording standard for SRO files is referred to as the stream recording (SR) standard arbitrarily.

Although not shown, the directory (DVD_HDVR directory) of the video manager file is composed of an HD_DVD-VR-format management information file HR_MANAGER.IFO, an HDVR_VOB directory including a VRO file (an EVOB file allowed to have a rate of up to 30.24 Mbps) which is an analog video input object file, and an HDVR_SOB directory including a digital-broadcasting-compatible SRO file (ESOB file). The DVD_RTAV directory under the same root directory as that of the DVD_HDVR directory is composed of a DVD-VR-format management file VR_MANGER.IFO and a VRO file (a conventional DVD-VR VOB file whose maximum rate has been suppressed to 10.08 Mbps) which is an analog video input object file.

Specifically, in the file structure of the embodiment, the HDVR MPEG2-TS data file, HDVR MPEG2-PS data file, and VR MPEG2-PS data file are managed under the same root directory. For example, if the short cut files linked with HR_MOVIE.VRO are set as title thumbnails A, C, the short cut files linked with VR_MOVIE.VRO are set as title thumbnail B, and the short cut files linked with HR_STRnn.SRO are set as title thumbnail D, these thumbnails A to D can be displayed on the same menu screen (see an example of the monitor screen 52a of FIG. 9). This enables the user to manipulate separate objects (objects where MPEG2-PS and MPEG2-TS are mixed) by menu operations under the same screen operation environment.

FIG. 9 is a block diagram to help explain an example of the configuration of a recording and reproducing apparatus (HD_DVD recorder) according to an embodiment of the invention. The analog AV output of a TV tuner 10 which has the function of receiving satellite digital TV broadcasting, terrestrial digital TV broadcasting, and terrestrial analog TV broadcasting is input to a Video ADC 14 and an Audio ADC 16. An analog AV input from an external analog input terminal 12 is also input to the Video ADC 14 and Audio ADC 16. The video stream digitized at the Video ADC 14 and the audio stream digitized at the Video ADC 16 are input to an MPEG Encoder 20. The digital stream (such as MPEG2-TS) from the external digital input terminal 18 is input via an interface 19, such as an IEEE 1394 (or HDMI) to an MPEG Encoder 20. Although not shown, the digital stream (such as MPEG2-TS) from a TV tuner 10 is input to the MPEG Encoder 20, if needed. The MPEG Encoder 20 encodes the input stream into MPEG2-PS or MPEG4-AVC unless it causes the input MPEG2-TS to pass through.

Here, the case where the input stream is encoded into MPEG2-PS includes a case where the input stream is encoded into MPEG2-PS on the basis of the DVD-VR standard (the maximum rate is 10.08 Mbps; the maximum resolution is 720×480 or 720×576), a case where the input stream is encoded into MPEG2-PS at a high rate on the basis of the HD_DVD-VR standard (the maximum rate is 30.24 Mbps; the maximum resolution is 1920×1080), and a case where the input stream is encoded into MPEG2-PS at a low rate on the basis of the HD_DVD-VR standard (the maximum rate is 10.08 Mbps; the maximum resolution is 720×480 or 720×576).

The stream data encoded (or passed through) at the MPEG Encoder 20 is buffered temporarily in a high-speed memory, such as an SDRAM (Synchronous Dynamic Random Access Memory) 22. On the SDRAM 22, the following stream rewriting processes 1 to 3 are carried out suitably:

1. When Audio is Liner PCM, the value of sub_stream_id of Audio Pack is rewritten.

2. The contents of RD-PCK are rewritten.

3. Cipher in the CPRM is decoded once and then encrypted again in the AACS or vice versa.

The stream data buffered and processed at the SDRAM 22 is transferred to the HDD 104, HD_DVD Drive 26, or DVD Drive 28 according to the contents of the data. A high-capacity hard disc drive (e.g., 1 TB) is used as the HDD 104. A blue laser (e.g., wavelength λ=405 nm) is used for the HD_DVD Drive 26 and a red laser (e.g., wavelength λ=650 nm) is used for the DVD Drive 28.

The HD_DVD Drive 26 and DVD Drive 28 constitute a Drive Unit 24. The Drive Unit 24 includes two independent drives each of which includes a rotary drive system, an HD_DVD/DVD compatible drive (of the twin pickup type) which has a separate blue laser optical head and a separate red laser optical head both sharing a rotary drive system, or a two-wavelength optical system (of the single pickup type) which switches between a blue laser and a red laser both sharing a rotary drive system and an optical head mechanism.

In the embodiment of FIG. 9, two independent drives Drive 26 and Drive 28 each including a rotary drive system are used. As an information storage medium (blue laser optical disc 100, red laser optical disc 102) used in these drives, not only optical discs of the −R/−RW/RAM type but also optical discs of the +R/+RW type can be used with both a blue laser and a red laser. In the future, it will be possible to use a high-capacity optical disc using holograms.

The HD_DVD Drive 26 does recording and reproducing on the basis of the HD_DVD-VR standard and the DVD Drive 28 performs recording and reproducing on the basis of the DVD-VR standard. The DVD Drive 28 is further configured to be capable of recording and reproducing MPEG-PS data whose maximum rate and video attributes and the like fall in the range of the DVD-VR standard even if it is the data encoded on the basis of the HD_DVD-VR standard, at a constant speed or high speed by using a disc (such as a single-sided single layer DVD-R/RW/RAM, a single-sided double layer DVD-R, or a double-sided single layer DVD-RAM) 102 complying with the DVD-VR standard. (To give an actual example, NTSC video MPEG2-PS data recorded in the HDD 104 at a maximum rate of 10.08 Mbps is configured to be capable of being copied/dubbed into a disc 102 complying with the DVD-VR standard, even if it is the data encoded on the basis of the HD_DVD-VR standard. It goes without saying that the MPEG2-PS data encoded on the basis of the HD-DVD-VR standard can be copied/dubbed into the disc 100 complying with the HD_DVD-VR standard at high speed.)

The stream data reproduced at the HD_DVD Drive 26, DVD Drive 28, and/or HDD 104 is transferred via the SDRAM 22 to an MPEG Decoder 30. The MPEG Decoder 30 has the function of decoding MPEG2-TS, the function of decoding MPEG2-PS, the function of decoding MPEG4-AVC, and other decoding functions (e.g., the function of decoding VC-1 determined in the HD_DVD-VR standard). The video data (MPEG2-TS or MPEG2-PS) decoded at the MPEG decoder 30 is converted by a video DAC 32 into a standard picture quality or a high-definition picture quality analog video signal, which is output at a Video Out terminal 36. Moreover, the audio data decoded at the MPEG Decoder 30 is converted by an Audio DAC 34 into an analog audio signal, which is output at an Audio Out terminal 38. Furthermore, if the decoded data is MPEG2-TS, it is output suitably via an interface 37, such as IEEE1394 (or HDMI), at a Digital Out terminal to the outside. The AV signal (analog video signal and analog audio signal) decoded at the MPEG Decoder 30 and D/A converted at the DACs 32, 34 is input to an external monitor.

The operation of the recording and reproducing apparatus (HD_DVD recorder) of FIG. 9 is controlled by an MPU 40. The MPU 40 is provided with an EEPROM 42 which stores firmware and various control parameters, a work RAM 44, and a timer 46. The firmware of the MPU 40 includes a GUI display control unit 400 for providing a graphic user interface, an encode parameter detecting unit 402, a high-speed copying (high-speed dubbing) unit 404, a rate conversion copy (constant-speed copy/constant-speed dubbing) control unit 406, a recording/reproducing control unit (management information processing unit) 408, an AACS processing unit 210a (corresponding to the control section 210 in FIG. 2). The result of processing at the GUI display control unit 400 is displayed on the screen at an external monitor via an on-screen display unit (OSD) 50 (a title thumbnail display screen 52a, a dialogue box display screen 52b at the time of copy processing, and the like can be obtained by the processing at the OSD 50).

In the embodiment of FIG. 9, the HDD 104 may be a single ultrahigh-capacity HDD (e.g., 1 TB) or a plurality of high-capacity HDDs used in parallel (e.g., 500 GB+500 GB). The method of using the recording areas of the HDD includes a method of dividing the recording areas logically into a plurality of partitions and a method of specifying a use for each physical HDD. In the former method, the following can be considered: for example, of 1 TB, a first partition of 400 GB is allocated to MPEG2-TS recording (for TS titles) in digital high-definition digital broadcasting, a second partition of 400 GB is allocated to MPEG4-AVC recording (for HDVR titles) in digital high-definition digital broadcasting, and a third partition of 200 GB is allocated to analog broadcasting, digital broadcasting, or external input MPEG2-PS recording (for VR titles). In the latter method, the following can be considered: for example, a first 400-GB HDD is allocated to MPEG2-TS recording (for TS titles), a second 400-GB HDD is allocated to MPEG4-AVC recording (for HDVR titles), and a third 200-GB HDD is allocated to MPEG2-PS recording (for VR titles).

In the embodiment, the VR titles include not only MPEG2-PS recording according to the existing DVD-VR standard but also MPEG2-PS recording with the maximum rate suppressed to 10.08 Mbps in the next-generation HD_DVD standard. Whether stream data on a certain VR title is MPEG2-PS complying with the DVD-VR standard or MPEG2-PS with the maximum rate suppressed to 10.08 Mbps in the HD-DVD standard can be determined at the object data level, depending on whether the contents of specific information (e.g., program maximum rate “program_mux_rate”) in the object data is 10.08 Mbps or 30.24 Mbps. Moreover, at the management information level, the same can be determined before the reproduction of the title is started, depending on whether specific information (e.g., video attribute “V_ATR”) in the management information includes an impossible resolution (e.g., 1280×1080) in the existing DVD-VR standard.

The aforementioned types of titles (TS title, HDVR title, and VR title) are file-managed in the same directory in the embodiment. For this reason, icons of the plurality of types of titles (TS title, HDVR title, and VR title) or thumbnails can be displayed on the same screen 52a. This enables the user to manipulate them in a similar manner even if each of the plurality of titles has been recorded according to any standard (such as HD_DVD-VR or DVD-VR) under any condition.

The system of FIG. 9 roughly comprises a disc drive unit 24 which accesses a medium and reads and writes data, a system processor (MPU) 40 which supervises system control, a User Interface section (included in the GUI control section) 400 which transmits an instruction from the user (a user operation instruction from a remote controller 60), and a data storage area 44 (and/or 42) which is used to hold data. In the system processor (MPU) 40, control units 402 to 408 which control the system, a data processing unit (AACS processing unit) 210a which encrypts and decrypts a Title Key File (TKF) and data related to the TKF exist in the form of firmware.

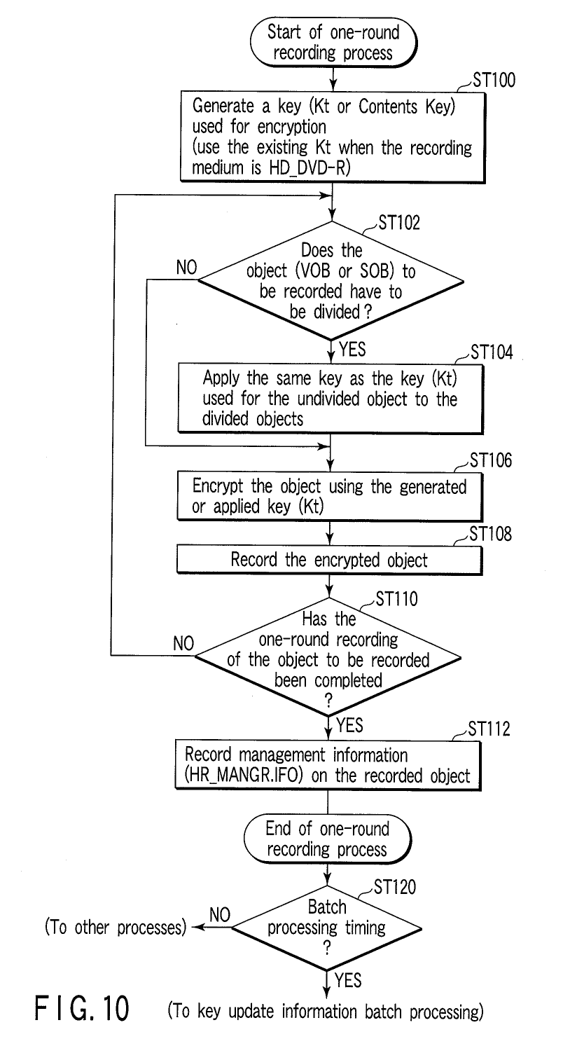

FIG. 10 is a flowchart to help explain a recording method according to the embodiment. The processing in the recording method is performed each time an object (VOB or SOB) is recorded. For example, suppose program A and program B in copyrighted digital broadcasting have been timer-recorded using an electronic program guide (EPG) or the like (the timer-recording process can be executed by, for example, the firmware of the MPU 40). In this case, when timer recording of program A is performed, the process of FIG. 10 is executed (using a certain encryption key. For example, a video object VOB (MPEG4 AVC or the like) corresponding to program A is encrypted and the resulting data is recorded onto an optical disc or a hard disc. Moreover, when program B is timer-recorded, the process of FIG. 10 is executed again (using another encryption key). For example, a stream object SOB (such as MPEG2 TS) corresponding to program B is encrypted. The resulting data is recorded onto an optical disc (e.g., 100 in FIG. 9) or a hard disc (e.g., 104 in FIG. 9).

When a one-round recording is started as described above, a key (title key Kt or Contents key) used for encryption in the AACS scheme is generated (ST100). The key generating process can be carried out in the same manner as the process explained with reference to FIG. 3. If the recording medium is a rewritable medium, such as a hard disc or an HD_DVD-RW/RAM, a new key is generated in ST100. However, if the recording medium is a write-once medium, such as an HD_DVD-R (or a single-sided double-layer HD_DVD-R: DL), which prevents overwriting and an encrypted object has already been recorded on a part of the medium, the existing key (Kt) used for the encryption is used for encryption in a recording process to be carried out (since the existing key file cannot be updated by overwriting in the write-once medium, the existing key is used as it is).

If the object is not divided in the middle of recording an object to be recorded (no at ST102), the object is encrypted using the key generated in ST100 (in the AACS scheme) (ST106) and the encrypted object is recorded onto a recording medium (a hard disc, an optical disc, or a semiconductor memory) (ST108). The processes in ST202 to ST110 are repeated until the one-round recording of the object to be recorded has been completed (no at ST110).

When the object is divided because of the change of, for example, a recording pause or a video attribute in the middle of recording an object to be recorded (e.g., SOB in program B) (yes at ST102), if a subsequent recording process is counted as another recording process, the recording is not an apparent one-round recording process. However, in that case, it is regarded as an event in a one-round recording, the key (Kt) used for encryption of the object before division (e.g., SOB in the first half of program B) is applied to the object after division (e.g., SOB in the second half of program B) (ST104). By doing this, a new key generating process (the process as described with reference to FIG. 3) can be omitted. Accordingly, a time lag for generating a new key is eliminated, which makes it possible to encrypt the object after division (ST106) and record the encrypted object (ST108) without delay (specifically, it is possible to eliminate the possibility that the beginning will be missing in continuing to record the object after division).

When a one-round recording of the object to be recorded has been finished as described above (yes at ST110), various pieces of management information needed in reproducing the recorded object are recorded in an HR_MANGR.IFO file (not shown) (ST112), which completes the recording process of FIG. 10. Thereafter, if batch process timing for information on the key used in each recording (or the key updated each time recording is done) has arrived (yes at ST120), the batch processing (as shown in FIGS. 12 to 16) is performed. Until the batch process timing has arrived (no at ST120), processes other than the batch process are executed, which avoids causing the user to wait for the end of the batch processing.

FIG. 11 is a flowchart to help explain a reproducing method according to the embodiment. Management information on an object to be reproduced (e.g., SOB of program B) is read from the disc 100 on which object data (VOB and/or SOB) and management information have been recorded by the process as shown in FIG. 10 (ST200). The read-out management information is stored temporarily in the work memory (such as 44 in FIG. 9) of a reproducing unit.

The reproducing unit (corresponding to 200 in FIG. 2) reads information (information for generating Km, Kpa, Kt, and the like) on the encryption of an object to be reproduced from an optical disc (e.g., 100 in FIG. 9) or a hard disc (e.g., 104 in FIG. 9) (ST202) and generates a decryption key (Kt or Contents Key) from the read-out information (S204). Here, information for generating Km, Kpa, Kt, and the like means Lead-in MKB, Read Write MKB, Binding Nonce, Title Key File, Title Usage File, and the like (see FIG. 2). The decryption key generating process can be carried out in the same manner as the process explained with reference to FIG. 2. Using the management information (HR_MANGR.IFO file) read in this way and the generated decryption key (Kt or Contents Key), the object to be reproduced is decrypted and reproduced (ST206). When the reproducing process has been carried out until the end of the object to be reproduced (or when the user or the control program of the apparatus has given a reproduction stop instruction) (yes at ST208), the reproducing process of FIG. 11 ends.

The following is an explanation of an implementation method of, when the nearest TKF is written at the time of the ejection or replacement of a recording medium (or disc), collectively processing update information accumulated from the insertion of the recording medium or the turning on of the power supply and writing the resulting information.

FIG. 12 is a flowchart to help explain a key information update recording method according to the embodiment. First, the system processor (MPU) 40 issues a TKF update instruction (ST10A). The system processor 40 checks whether the target TKF, data related to the TKF, and backup data (hereinafter, referred to as the TKF data group) exist in the data storage area (Work RAM) 44 (ST12A). If they exist (yes at ST12A), control proceeds to ST16A. If they do not exist (no at ST12A), the system processor 40 issues a data acquisition instruction to the disc drive unit 24, gets the TKF data group, and stores it in the data storage area 44 (ST16A). Here, the system processor 40 carries out an update process, including the addition, deletion, and re-encryption of data, at the data processing unit 210a to update the TKF data group and stores (or accumulates) the updated TKF data group in the data storage area 44 (ST16A).

The processes in ST10A to ST16A are repeated each time the TKF is updated until the GUI 400 of FIG. 9 has made a disc eject request or, when a disc changer function is used, has made a disc replacement request (or a disc change request).

When the GUI 400 has made a disc eject or replacement request (Yes in ST120), the system processor 40, using this as specific timing, acquires the updated TKF data group from the data storage area 44 (ST18A). Then, the system processor 40 causes the disc drive unit 24 to write the acquired TKF data group onto the recording medium (100 or the like) (ST20A). (The medium on which the TKF data group is written is not limited to an optical disc and may be a HDD or a high-capacity flash memory.)

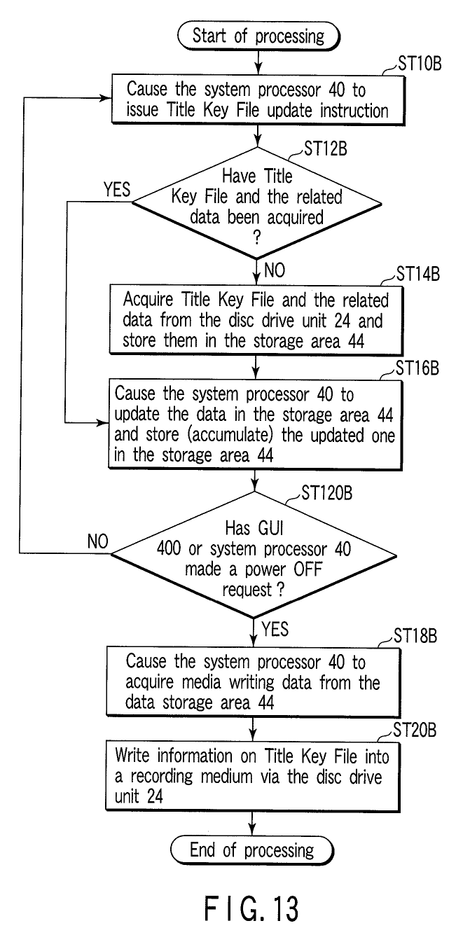

FIG. 13 is a flowchart to help explain a key information update recording method according to another embodiment of the invention. This process is an example of an implementation method of, when the nearest TKF is written at the time of the turning off of the power supply, collectively processing update information accumulated from the insertion of the recording medium or the turning on of the power supply and writing the resulting information. In FIG. 13, the processes in ST10B to ST16B are the same as those in ST10A to ST16A described above.

The processes in ST10B to ST16B are repeated each time the TKF is updated until a power off request has been made by the power button on the remote controller 60 (FIG. 9) via the GUI 400, a power off request has been made by the power button on the operation panel (not shown) of the device, or the system processor 40 has given a power off instruction at the end of timer recording.

If a power off process has been carried out (yes at ST120B), the system processor 40, using this as specific timing, acquires the updated TKF data group from the data storage area 44 (ST18B). Then, the system processor causes the disc drive unit 24 to write the acquired TKF data group onto the recording medium (100 or the like) (ST20B). (The medium on which the TKF data group is written is not limited to an optical disc and may be a HDD or a high-capacity flash memory.)

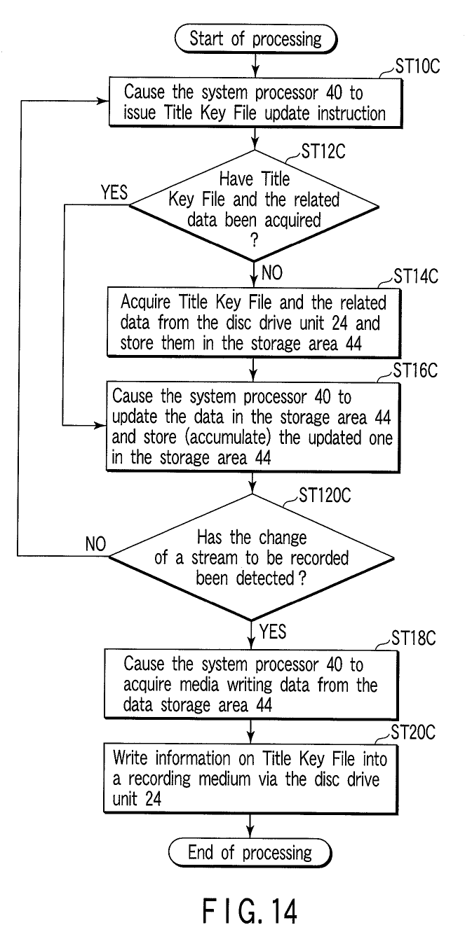

FIG. 14 is a flowchart to help explain a key information update recording method according to still another embodiment of the invention. This process is an example of an implementation method of, when the nearest TKF is written at the time of the change of the recording format (such as the PES format in MPEG2-PS or the TS format in MPEG2-TS), collectively processing update information accumulated from the insertion of the recording medium or the turning on of the power supply and writing the resulting information. In FIG. 14, the processes in ST10C to ST16C are the same as those in ST10A to ST16A described above.

The processes in ST10C to ST16C are repeated each time the TKF is updated until, for example, the system processor 40 has detected the change of the recording format, such as the change of MPEG2-PS recording (where a recording object is a video object VOB) into MPEG2-TS recording (where a recording object is a stream object SOB).

If the change of the recording format of a stream to be recorded has been detected (yes at ST120C), the system processor 40, using this as specific timing, acquires the updated TKF data group from the data storage area 44 (ST18C). Then, the system processor causes the disc drive unit 24 to write the acquired TKF data group onto the recording medium (100 or the like) (ST20C). (The medium on which the TKF data group is written is not limited to an optical disc and may be a HDD or a high-capacity flash memory.)

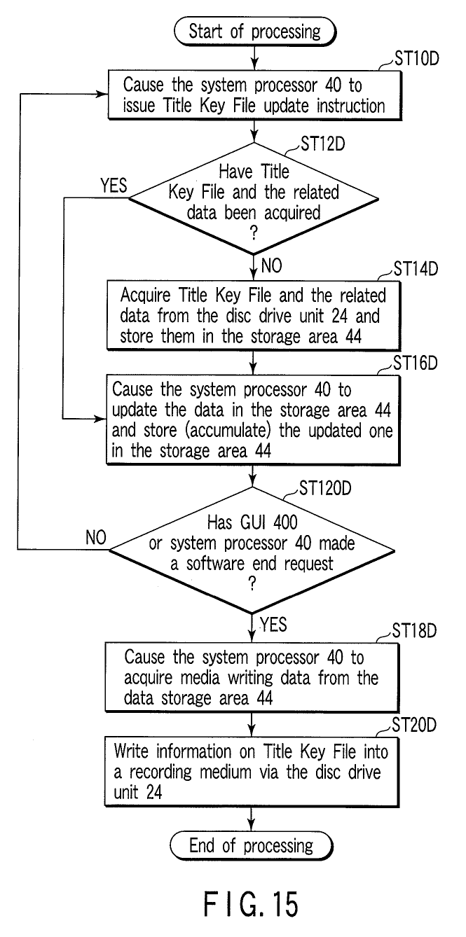

FIG. 15 is a flowchart to help explain a key information update recording method according to still another embodiment of the invention. This process is an example of an implementation method of, when the nearest TKF is written at the end of the recording software, collectively processing update information accumulated from the insertion of the recording medium or the startup of the software and writing the resulting information. In FIG. 15, the processes in ST10D to ST16D are the same as those in ST10A to ST16A described above.

The processes in ST10D to ST16D are repeated each time the TKF is updated until a software end request (e.g., a forced termination of program recording by the user in the middle of timer recording) has been made by the remote controller 60 (FIG. 9) via the GUI 400 or a software end instruction has been given by the system processor 40 at the end of the timer recording or the like with the power supply being kept on.

If the software end process has been carried out (yes at ST120D), the system processor 40, using this as specific timing, acquires the updated TKF data group from the data storage area 44 (ST18D). Then, the system processor causes the disc drive unit 24 to write the acquired TKF data group onto the recording medium (100 or the like) (ST20D). (The medium on which the TKF data group is written is not limited to an optical disc and may be a HDD or a high-capacity flash memory.)

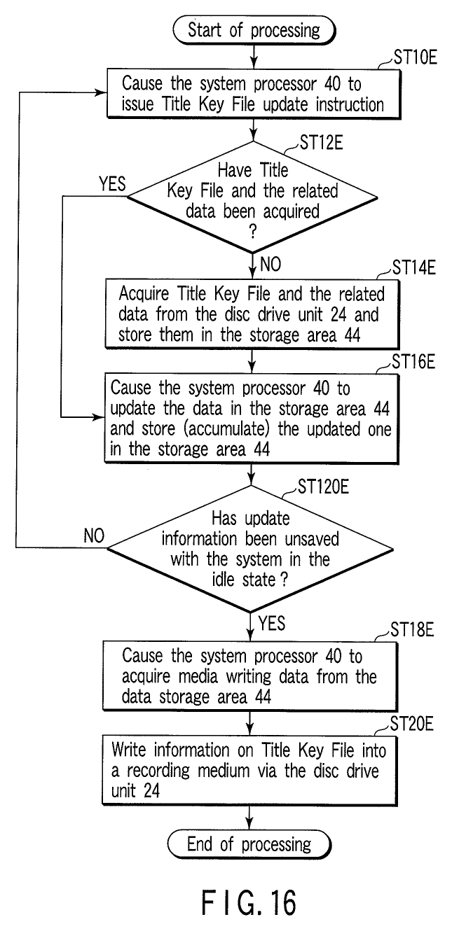

FIG. 16 is a flowchart to help explain a key information update recording method according to still another embodiment of the invention. This process is an example of an implementation method of, if it has been detected that update information on the TKF has not been saved, when the system has gone into the idle state as in the timer recording standby state using the EPG, collectively processing update information accumulated from the insertion of the recording medium or the turning on of the power supply and writing the resulting information. In FIG. 16, the processes in ST10E to ST16E are the same as those in ST10A to ST16A described above.

The processes in ST10E to ST16E are repeated each time the TKF is updated until the system processor 40 has detected that update information on the TKF has not been saved with the system in the idle state (e.g., in the timer recording standby state using the EPG). (Whether or not update information on the TKF has not been saved can be detected easily by attaching to the update information a flag that indicates update information has been saved.

If unsaved update information has been detected when the system has gone into the idle state (e.g., if update information with the unsaved flag up is in the memory 44) (yes at ST120E), the system processor 40, using this as specific timing, acquires the updated TKF data group from the data storage area 44 (ST18E). Then, the system processor causes the disc drive unit 24 to write the acquired TKF data group onto the recording medium (100 or the like) (ST20E). (The medium on which the TKF data group is written is not limited to an optical disc and may be a HDD or a high-capacity flash memory.)

<Summarization>

1. To update the Title Key File (TKF), it is demanded to reset and re-encrypt the TKF and the files related to the TKF and write the resulting data onto a medium. Instead of carrying out a media writing process each time the TKF is updated, update information accumulated from the immediately preceding writing (or the previous writing) are collectively processed and written when the medium (or disc) is ejected or replaced.

2. When the power off process is carried out, update information accumulated from the immediately preceding TKF writing (or the previous TKF writing) are collectively processed and written.

3. When the recording format (such as the PES format or TS format) has been changed, update information accumulated from the immediately preceding TKF writing (or the previous TKF writing) are collectively processed and written.

4. In the end processing of a recording software program, update information accumulated from the start of the software program or from the immediately preceding TKF writing (or the previous TKF writing) are collectively processed and written.

5. With the system in the idle state, if the TKF writing has not been done, accumulated update information are collectively processed and written.

### Effects of the Embodiments

(1) In the system using the AACS, the TKF data group has to be updated each time the TKF is updated. At that time, since the data in an area which cannot be accessed by an ordinary Read/Write method also has to be updated, updated information on the TKF data group is written onto the recording medium each time the information is updated, which takes time. Using the embodiments of the invention makes it unnecessary to write data onto the recording medium in updating the TKF data group until the change of the recording medium or the end of the system. This makes it possible to shorten the time for the next process to start.

(2) A file for the TKD data group is prepared for each recording format. For this reason, if only embodiment 1 and embodiment 2 are performed, files have to be managed simultaneously in separate recording formats.

Using the present embodiment makes it easier to manage the files in the TKF data group and enables the size of the data storage area needed to be decreased.

(3) In the system using the AACS, the TKF data group has to be updated each time the TKF is updated. At that time, since the data in an area which cannot be accessed by an ordinary Read/Write method also has to be updated, updated information on the TKF data group is written onto the recording medium each time the information is updated, which takes time. Using the embodiments of the invention makes it unnecessary to write data onto the recording medium in updating the TKF data group until the end of writing software. This makes it possible to shorten the time for the next process to start.

This invention is not limited to the above embodiments and, on the basis of available skills in the present or future implementation phase, may be practiced or embodied in still other ways without departing from the spirit or character thereof. For instance, the information storage medium used in the embodiments is not limited to an optical disc or a hard disc, and may be a high-capacity flash memory or the like.

The individual embodiments may be combined suitably if at all possible, which produces the effects of the combinations. The embodiments include inventions of different stages and therefore various inventions can be extracted by combining suitably a plurality of structural requirements disclosed in the embodiments. For example, even if some are removed from all of the structural requirements shown in the embodiments, the resulting configuration can be extracted as an invention.

What is claimed is:

1. A method of encrypting an object using key information to be updated and recorded into a medium, the method comprising:
updating, at a specific timing, the key information and writing the updated information into the medium.

2. The method according to claim 1, further comprising:
in a case where the medium is a removable medium to be installed in a media drive unit, writing update information accumulated from previous writing of key information into the removable medium using as the specific timing a time when the removable medium is ejected from or replaced at the media drive unit.

3. The method according to claim 1, further comprising:
in a case where the medium is a medium to be used in a recording and reproducing apparatus for the object, writing update information accumulated from previous writing of the key information into the medium using as the specific timing a time when a power supply of the recording and reproducing apparatus is turned off.

4. The method according to claim 1, further comprising:
in a case where the object corresponds to a digital stream encoded in a first format or a second format, writing update information accumulated from previous writing of the key information into the medium using as the specific timing a time when the encode format of the object is changed from one of the first and second formats to the other.

5. The method according to claim 1, further comprising:
in a case where a process of recording data of the object into the medium is carried out in software, writing update information on the key information accumulated from a start of the software or from previous writing of the key information into the medium, using as the specific timing a time of end processing of the software.

6. The method according to claim 1, further comprising:
in a system configured to record data of the object into the medium, when it is detected that updated information on the key information has not been written yet where the system has gone into an idle state, writing accumulated update information on the key information into the medium using as the specific timing a time of detection that the updated information on the key information has not been written yet where the system has gone into the idle state.

7. The method according to claim 1, further comprising:
cumulatively storing the update information until the specific timing has been reached.

8. A method of reading information on the encryption from the medium as defined in claim 1, further comprising:
generating a decryption key from the read-out information, and
reproducing the encrypted object data, while decrypting the encrypted object data using the generated decryption key.

9. A recording apparatus comprising:
an encrypter configured to encrypt an object using key information to be updated;
a recording configured to record the encrypted object data into a medium; and
a processor configured to carry out, at a specific timing, a process of updating the key information and a process of writing update information obtained as a result of the update process into the medium.

10. A recording and reproducing apparatus comprising:
a reader configured to read encrypted object data and information on the encryption from a medium;
a generator configured to generate a decryption key from the read-out information on the encryption; and
a reproducer configured to reproduce the encrypted object data, while decrypting the encrypted object data using the generated decryption key.
